(19) United States
(12) Patent Application Publication
(10) Pub. No.: US 2006/0088398 A1
(43) Pub. Date: Apr. 27, 2006

(54) Alignment washer

(76) Inventor: Casey B. Lund, Midpines, CA (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/246,775

(22) Filed: Oct. 7, 2005

Related U.S. Application Data
(60) Provisional application No. 60/616,677, filed on Oct. 7, 2004.

(51) Int. Cl. F16B 39/24

(52) U.S. Cl. 411/155; 411/398

(57) ABSTRACT

The present invention is an offset washer assembly for use with a fastener (i.e., a bolt, cotter pin, etc.). The washer comprises an inner washer and an outer washer. The inner washer includes a first hole therein adapted to receive the fastener. The first hole passes through the inner washer such that the center point of the first hole is offset from a center point of the inner washer. The outer washer includes a second hole therein adapted to receive the inner washer. The second hole passes through the outer washer such that the center point of the second hole is offset from a center point of the outer washer. The inner washer is movable within the second hole to adjust an amount of offset between the longitudinal axis of the fastener and the center point of the outer washer. The outer washer is movable relative to equipment to be secured by the fastener to adjust the location of the second hole relative to the equipment.

### RELATED APPLICATIONS

This application claims priority to U.S. Provisional Patent Appl. Ser. No. 60/616,677, entitled Double Eccentric Washer, filed on Oct. 7, 2004, which is incorporated by reference herein.

### FIELD OF THE INVENTION

The present invention relates to apparatus for, and methods of, connecting or securing items together. More particularly, the present invention relates to washers and methods of employing washers with fasteners such as bolts, cotter pins, etc.

### BACKGROUND OF THE INVENTION

It is common to connect two or more items together by passing a fastener (i.e., a threaded bolt, cotter pin, etc.) through a hole in each of the items. Where the fastener is a bolt, the bolt is then threaded into one of the items or a nut is threaded onto the bolt. To allow a fastener to pass through the holes, the holes must be properly aligned. However, due to manufacturing (i.e., tolerance) variations in the items or aftermarket modifications to the items or their installation, it is often difficult to properly align the holes to receive the fastener.

There is a need in the art for a device that will allow a fastener to pass through misaligned holes in such a manner that will allow the fastener to be used to secure together the items having the holes. There is also a need in the art for a method of allowing a fastener to pass through misaligned holes in such a manner that will allow the fastener to be used to secure together the items having the holes.

### BRIEF SUMMARY OF THE INVENTION

The present invention, in one embodiment, is an offset washer for use with a fastener (i.e., a bolt, cotter pin, etc.). The washer includes an inner washer and an outer washer. The inner washer includes a first hole therein adapted to receive the fastener. The first hole passes through the inner washer such that a center of the first hole is offset from a center of the inner washer. The outer washer includes a second hole therein adapted to receive the inner washer. The second hole passes through the outer washer such that a center of the second hole is offset from a center of the outer washer. The inner washer is movable, such as by rotation, translation, etc., relative to the outer washer to adjust an amount of offset between the center of the first hole and the center of the outer washer.

Another embodiment of the present invention is a system for joining items. The system includes an inner washer, an outer washer, a first item, and a second item. The inner washer includes a first hole therein adapted to receive the fastener. The first hole passes through the inner washer such that a center of the first hole is offset from a center of the inner washer. The outer washer includes a second hole therein adapted to receive the inner washer. The second hole passes through the outer washer such that the center of the second hole is offset from a center of the outer washer. The inner washer is movable relative to the outer washer to adjust an amount of offset between the center of the first hole and the center of the outer washer. The first item includes a third hole adapted for receiving the fastener. The second item includes a fourth hole sized to encompass the third hole and adapted to receive the outer washer. The outer washer is movable relative to the second item to adjust the location of the center of the second hole relative to a center of the fourth hole.

Another embodiment of the present invention is an offset washer. The washer includes an inner portion and an outer portion. The inner portion includes a first hole therein adapted to receive the fastener. The first hole passes through the inner portion such that a center of the first hole is offset from a center of the inner portion. The outer portion includes a second hole therein that encompasses the first hole. The second hole passes through the outer portion such that a center of the second hole is offset from a center of the outer portion. The inner washer is movable relative to the outer portion to adjust an amount of offset between the center of the first hole and the center of the outer portion.

Another embodiment of the present invention is an offset washer. The washer includes an inner washer and an outer washer. The inner washer includes a plurality of holes therein adapted to receive the fastener. At least one of the plurality of holes has a center offset from the center of the inner washer. The outer washer includes a second hole therein adapted to receive the inner washer. The second hole passes through the outer washer such that a center of the second hole is offset from a center of the outer washer. The inner washer is movable relative to the outer washer to adjust an amount of offset between at least one of the centers of the plurality of holes and the center of the outer washer.

Another embodiment of the present invention is an offset washer assembly. The offset washer assembly includes a fastener and a washer. The longitudinal axis of the shaft is offset from the center of the head. The washer includes a hole therein adapted to receive the fastener. The hole passes through the washer such that a center of the hole is offset from a center of the washer. The head of the washer is movable relative to the washer to adjust an amount of offset between the longitudinal axis of the shaft and the center of the washer.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is an exploded isometric view of one embodiment of the subject invention, which is a washer assembly.

FIG. 1A is a simplified plan view of an inner washer.

FIG. 1B is a simplified plan view of an outer washer.

FIG. 2 is the washer assembly as viewed from the direction of arrow A in FIG. 1 wherein the centerline of the fastener coincides with the center of the outer washer.

FIG. 3 is a cross section taken along section line A-A in FIG. 2.

FIG. 4 is the similar view of the washer assembly as illustrated in FIG. 2, except the centerline of the fastener is offset from the center of the outer washer.

FIG. 5 is a cross section taken along section line B-B in FIG. 4.

FIG. 6 is a section of one embodiment of the washer assembly as if taken along section line A-A in FIG. 2.

FIG. 7 is an isometric view of the washer assembly assembled wherein the rim portions of the inner and outer washers are each provided with an indicator mark.

FIG. 8 is an isometric view of the washer assembly assembled wherein the rim portions of the inner and outer washers are each provided with an indicator mark.

FIG. 9 is a plan view of a washer assembly being employed to secure together items.

FIG. 10 is a section taken along section line D-D in FIG. 9 and illustrating a washer assembly being employed to secure two items together.

FIG. 10A is a section as if taken along section line D-D in FIG. 9 and illustrating the items to be secured together prior to a washer assembly being employed.

FIG. 11 is another plan view of a washer assembly being employed to secure together items.

FIG. 12 is a section taken along section line E-E in FIG. 11 and illustrating a washer assembly being employed to secure two items together.

FIG. 12A is a section as if taken along section line E-E in FIG. 11 and illustrating the items to be secured together prior to a washer assembly being employed.

FIG. 13 is a plan view of the inner and outer washer showing an area of potential locations for the center of the hole in the inner washer relative to the center of the outer washer.

FIG. 14 is a plan view of the inner and outer washer showing another area of potential locations for the center of the hole in the inner washer relative to the center of the outer washer.

FIG. 15 is a cross section as if taken along section line A-A in FIG. 2 showing an outer washer crimped on an inner washer.

FIG. 16 is an isometric view of a second embodiment of a washer assembly.

FIG. 17 is a cross section taken along section line C-C in FIG. 16.

FIG. 18 is an exploded isometric view of third embodiment of a washer assembly.

FIG. 19 is a simplified plan view of an inner washer with a plurality of holes.

FIG. 20 is an exploded isometric view of a fourth embodiment of a washer assembly.

FIG. 21 is an exploded isometric view of a fifth embodiment of a washer assembly.

FIG. 22 is an elevation view of an offset fastener.

FIG. 23 is a plan view of an offset fastener.

FIG. 24 is section view of an inner and outer washer being employed for the securing of a first item to a second item having an integral fastener.

FIG. 25 is a plan view of a washer assembly being employed to secure together items.

FIG. 26 is a section taken along section line F-F in FIG. 25 and illustrating a washer assembly being employed to secure two items together.

FIG. 27 is a plan view of a washer assembly being employed to secure together items.

FIG. 28 is a section taken along section line G-G in FIG. 27 and illustrating a washer assembly being employed to secure two items together.

FIG. 29 is a plan view of a washer assembly being employed to secure together items.

FIG. 30 is a section taken along section line H-H in FIG. 29 and illustrating a washer assembly being employed to secure two items together.

FIG. 31 is a plan view of a washer assembly being employed to secure together items.

FIG. 32 is a section taken along section line J-J in FIG. 31 and illustrating a washer assembly being employed to secure two items together.

FIG. 33 is a plan view of a washer assembly being employed to secure together items.

FIG. 34 is a section taken along section line K-K in FIG. 33 and illustrating a washer assembly being employed to secure two items together.

FIG. 35 is a plan view of a washer assembly being employed to secure together items.

FIG. 36 is a section taken along section line L-L in FIG. 35 and illustrating a washer assembly being employed to secure two items together.

### DETAILED DESCRIPTION

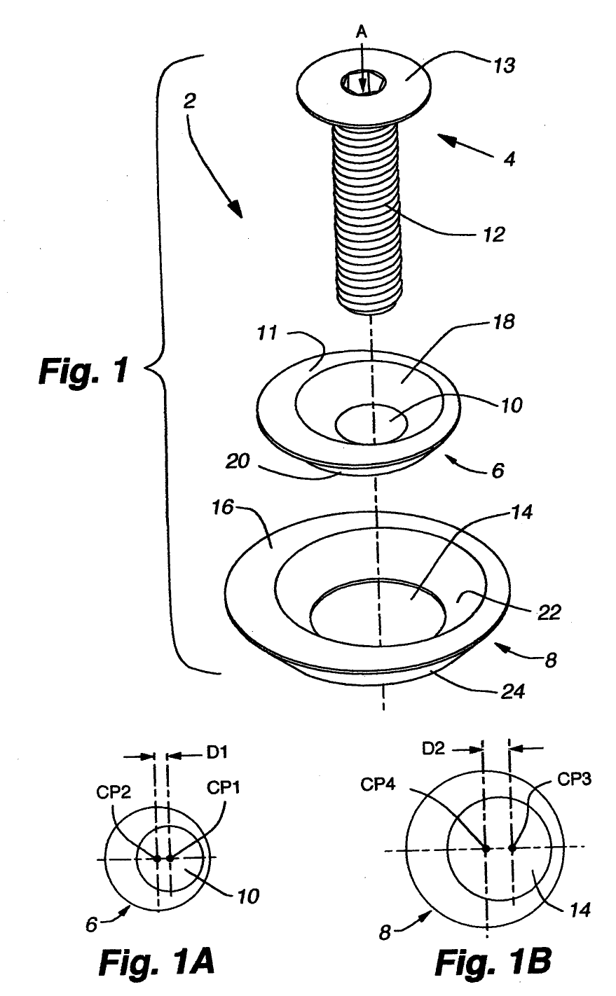

FIG. 1 is an exploded isometric view of one embodiment of the subject invention. As will be understood from this Detailed Description, the present invention is advantageous because it allows two or more items to be joined by a fastener 4 (e.g., a threaded bolt, a cotter pin, etc.) although the holes in the items are not perfectly aligned due to such factors as manufacturing (i.e., tolerance) variations between the items or other hole misalignment factors.

As shown in FIG. 1, in one embodiment, a first washer assembly 2 includes a fastener 4, an inner washer 6, and an outer washer 8. The fastener 4 includes a shaft 12 and a head 13. The inner washer 6 includes a hole 10 therein adapted to receive the shaft 12 of the fastener 4, a rim portion 11, an inner surface 18, and an outer surface 20, and the outer washer 8 includes a hole 14 therein adapted to receive the inner washer 6, a rim portion 16, an inner surface 22, and an outer surface 24. As shown in FIGS. 1A and 1B, the center CP1 of hole 10 is offset from the center CP2 of the inner washer 6, and the center CP3 of hole 14 is offset from the center CP4 of the outer washer 8. In one embodiment, as shown in FIG. 1, the inner washer's 6 hole 10 is counter sunk to also receive the head 13 of the fastener 4. The washers 6, 8 (and the washers described in other washer assembly embodiments) may be composed of any type of material used for washers including metal, rubber, or plastic. Similarly, the fastener 4 (and the fasteners described in other washer assembly embodiments) may be composed of any type of material used for fasteners including metal or plastic.

In the embodiment depicted in FIG. 1, the holes 10, 14 and the inner and outer surfaces 18, 20, 22, 24 of the inner and outer washers 6, 8 have generally circular perimeters along the depths of the washers 6, 8. Other geometric perimeters that allow the inner washer 6 to be moved, such as by rotation, translation, etc., relative to outer washer 8, and the outer washer 8 to be moved such as by to rotation, translation, etc. relative to one or more items to be joined, may be utilized. For example, polygons that have equal sides such as equilateral triangles, squares, rectangles, parallelograms, etc. or curved shapes that are symmetrical about two perpendicular axis such as an ellipse or oval could be utilized as the perimeters for the holes 10, 14 or for the inner and outer surfaces 18, 20, 22, 24 of the inner and outer washers 6, 8 along the depths of the washers 6, 8.

An advantage of using a substantially circular perimeter for the outer surface 20 of the inner washer 6 and the inner surface 22 of the outer washer 8 is that the inner washer 6 can be rotated infinitely relative to the outer washer 8 when the inner washer 6 is contained within the hole 14 of the outer washer 8. In contrast, use of another perimeter such as a polygon with equal sides creates a finite number of ways to rotate or move the inner washer 6 relative to the outer washer 8 when the inner washer 6 is contained within the hole 14 of the outer washer 8. For example, if a square perimeter is used along the depths of the washers 6, 8 for the outer surface 20 of the inner washer 6 and the inner surface 22 of the outer washer 8, then there are four positions to rotate or move the inner washer 6 relative to the outer washer 8 when the inner washer 6 is contained within hole 14.

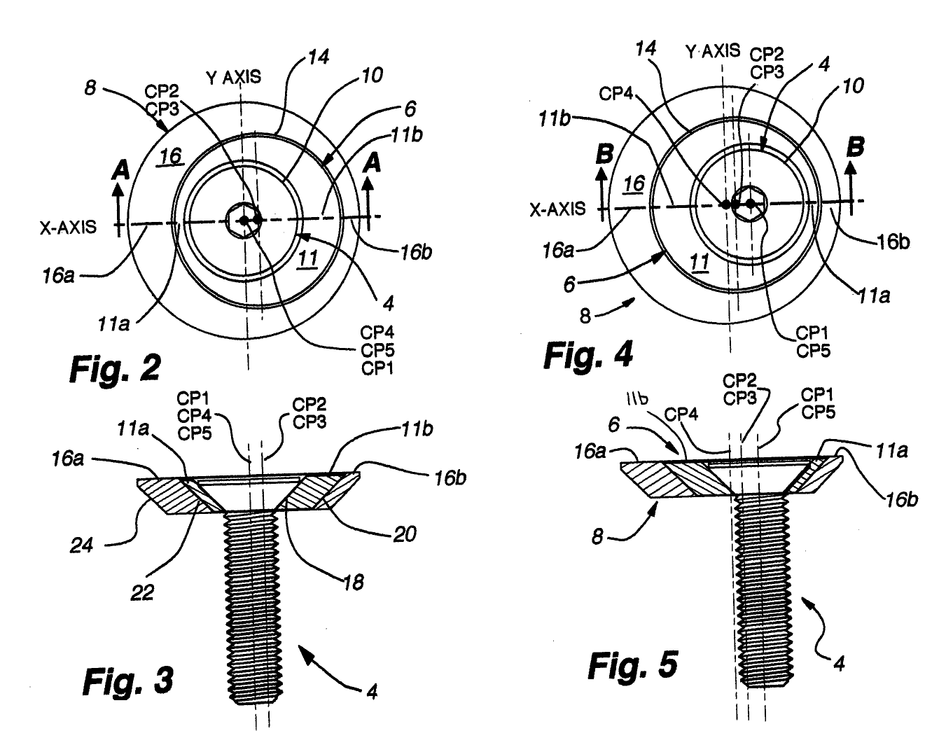

The outer washer 8 may be moved relative to one of the two or more items to be joined. Thus, with reference to FIGS. 2-5, by moving the inner washer 6 relative to the outer washer 8 (e.g., rotating inner washer 6 within the hole 14 of the outer washer 8) and moving the outer washer 8 relative to the item to be joined, the position of the longitudinal axis CP5 (i.e., center line) of the fastener 4 may be adjusted relative to the center CP4 of the outer washer 8. In other words, because the washers 6, 8 both are movable and both have holes 10, 14 therein (as shown in FIGS. 1A and 1B) whose centers CP1, CP3 do not coincide with their respective centers CP2, CP4, the position of the fastener's 4 centerline CP5 relative to the center CP4 of the outer washer 8 may be varied along both the X and Y axes. Thus, as will be described in more detail below, the first washer assembly 2 is advantageous because it makes it possible to position a fastener 4 through holes in items to be joined by tightening (or otherwise fastening) the fastener 4 when the holes in the items are not perfectly aligned. In one embodiment, once the fastener 4 is properly aligned and passing through the holes of the two or more items to be joined, the fastener 4 may be tightened to prevent further movement of the washers 6, 8.

For a better understanding of the washer assembly's 2 ability to allow a fastener 4 to pass through non-aligned holes, reference is now made to FIGS. 2-5. FIG. 2 is the first washer assembly 2 as viewed from the direction of arrow A in FIG. 1 wherein the center CP1 of the hole 10 of the inner washer 6 approximately coincides with the center CP4 of the outer washer 8 and the centerline CP5 of the fastener 4 approximately coincides with the center CP1 of the hole 10 of the inner washer 6. FIG. 3 is a cross section taken along section line A-A in FIG. 2. FIG. 4 is the same view of the first washer assembly 2 as illustrated in FIG. 2 except the center CP1 of the hole 10 of the inner washer 6 is offset from the center CP4 of the outer washer 8 and the centerline CP5 of the fastener 4 approximately coincides with the center CP1 of the hole 10 of the inner washer 6. FIG. 5 is a cross section taken along section line B-B in FIG. 4.

As shown in FIGS. 2 and 3, in one embodiment, when the holes 10, 14 of the inner and outer washers 6, 8 are arranged such that there is a minimum offset distance between center CP1 of the hole 10 of the inner washer 6 and the center CP4 of the outer washer 8, a narrowest part 11a of the inner washer's 6 rim portion 11 is immediately adjacent a widest part 16a of the outer washer's 8 rim portion 16. Also, a widest part 11b of the inner washer's 6 rim portion 11 is immediately adjacent a narrowest part 16b of the outer washer's 8 rim portion 16. Thus, in this configuration, the respective offset distance of the centers CP1, CP3 of the washer holes 10, 14 from the centers CP2, CP4 of their respective washers 6, 8 negate each other thereby resulting in a minimum offset distance between the center CP1 of hole 10 and the center CP4 of the outer washer 8. When the offset distances of the centers CP1, CP3 of the washer holes 10, 14 from the centers CP2, CP4 of their respective washers 6, 8 are approximately equal, the minimum offset distance between the center CP1 of the hole 10 of the inner washer 6 and the center CP4 of the outer washer 8 will be approximately zero as shown in FIGS. 2 and 3. Further, when the centerline CP5 of the fastener 4 approximately coincides with the center CP1 of the hole 10 of the inner washer 6 as shown in FIGS. 2 and 3, the offset distance between the centerline CP1 of the fastener 4 and the center CP4 of the outer washer 8 will be approximately zero. In other words, when the distance between the center CP2 of inner washer 6 and the center CP1 of the hole 10 of the inner washer 6 is approximately equal to the distance from the center CP4 of outer washer 8 and the center CP3 of the hole 14 of the outer washer 8, and the centerline CP5 of the fastener 4 approximately coincides with the center CP1 of the hole 10 of the inner washer 6, the centerline CP5 of the fastener 4, when the washers 6, 8 are configured in the minimum offset position, will approximately coincide with the center CP4 of the outer washer 8.

As shown in FIGS. 4 and 5, in one embodiment, when the holes 10, 14 of the inner and outer washers 6, 8 are arranged such that the center CP1 of the hole 10 of the inner washer 6 is offset by a maximum amount from the center CP4 of the outer washer 8, a narrowest part 11a of the inner washer's 6 rim portion 11 is immediately adjacent a narrowest part 16b of the outer washer's 8 rim portion 16. Also, a widest part 11b of the inner washer's 6 rim portion 11 is immediately adjacent a widest part 16a of the outer washer's 8 rim portion 16. Thus, the offset distances of the centers CP1, CP3 of the washer holes 10, 14 from the centers CP2, CP4 of their respective washers 6, 8 combine with each other to create a maximum offset distance between the center CP1 of the hole 10 of the inner washer 6 and the center CP4 of outer washer 8. Further, when the centerline CP5 of the fastener 4 coincides with the center CP1 of the hole 10 of the inner washer 6, the offset distance between the fastener's 4 centerline CP5 and the outer washer's 8 center CP4 will be at a maximum. Depending on the how the parts 11a, 11b of the inner washer's 6 rim portion 11 are positioned relative to the parts 16a, 16b of the outer washer's 8 rim portion 16, the amount of offset between the center CP1 of the hole 10 of the inner washer 6 and the center CP4 of the outer washer 8 may range between the minimum and the maximum offset distances. Further, when the centerline CP5 of the fastener 4 and the center CP1 of the hole 10 of the inner washer 6 approximately coincide, the amount of offset between the centerline CP5 of the fastener 4 and the center CP4 of the outer washer 8 will be approximately the same as the amount of offset between the center CP1 of the hole 10 of the inner washer 6 and the center CP4 of the outer washer 8.

In some embodiments, the minimum offset distance will be approximately zero and the maximum offset distance with be approximately the sum of the respective offset distance of the centers CP1, CP3 of the washer holes 10, 14 from the centers CP2, CP4 of their respective washers 6, 8. For example, with reference to FIGS. 1A and 1B, if both holes 10, 14 are generally circular and the offset distance D1 from the center CP1 of the hole 10 of the inner washer 6 to the center CP2 of inner washer 6 is approximately two-tenths of an inch (0.200″) and the offset distance D2 from the center CP3 of the hole 14 of the outer washer 8 to the center CP4 of the outer washer 8 is also approximately two-tenths of an inch (0.200″), the minimum value will be approximately zero and the maximum value will be approximately four-tenths of an inch (0.400″). In other embodiments, the minimum offset distance will not be approximately zero. For example, if both holes 10, 14 are generally circular and the offset distance D1 of the center CP1 of the hole 10 of the inner washer 6 from the center CP2 of the inner washer 6 is approximately one-tenth of an inch (0.100″) and the offset distance D2 from the center CP3 of the hole 14 of the outer washer 8 to the center CP4 of outer washer 8 is approximately two-tenths of an inch (0.200″ inches), the minimum value will be approximately one-tenth of an inch (0.100″) and the maximum value will be approximately three-tenths of an inch (0.300″). The numerical values provided in the examples above for the offset distances D1, D2 from the centers CP1, CP3 of the holes 10, 14 to the centers CP2, CP4 of their respective washers 6, 8 are merely illustrative. Accordingly, these offset distances D1, D2 could be greater than or less than the values provided in the example.

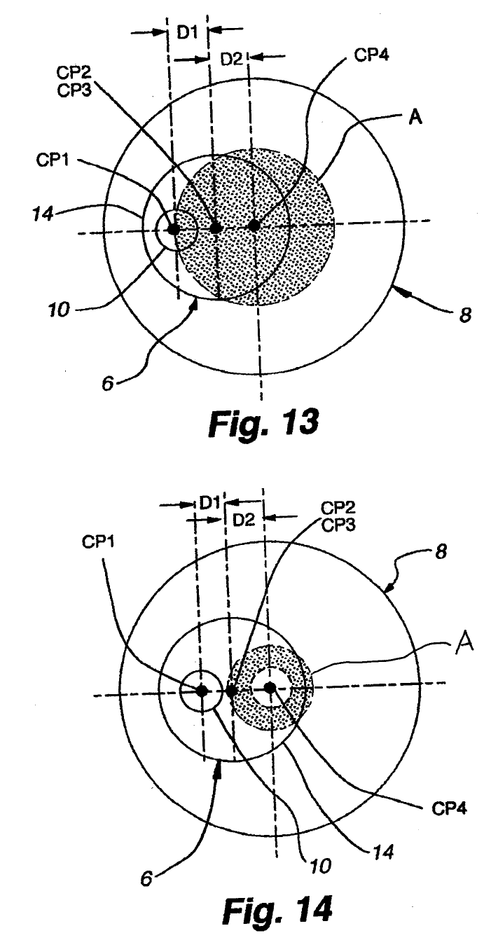

As depicted in FIG. 13, when the holes 10, 14 of the inner and outer washer 6, 8 and the perimeters of the inner and outer surfaces 18, 20, 22, 24 of the inner and outer washers 6, 8 (as depicted in FIG. 1) are generally circular and the offset distances D1, D2 of the centers CP1, CP3 of the holes 10, 14 from the centers CP2, CP4 of their respective washers 6, 8 are approximately the same, the area A, which is representative of potential locations for the center CP1 of the hole 10 of the inner washer 6 relative to the center CP4 of outer washer 8, is approximately a circle. The circle will have a center that approximately coincides with the center CP4 of outer washer 8 and a radius that is approximately equal to the maximum offset distance. Thus, in one of the illustrative examples above in which the offset distance between the centers CP1, CP3 of the holes 10, 14 and the centers CP2, CP4 of their respective washers 6, 8 was approximately two-tenths of an inch (0.200″), the radius of the circle for area A, which is centered on the center CP4 of outer washer 8, would be approximately four-tenths of an inch (0.400″).

In other embodiments, the area A, which represents potential locations of the center CP1 of the hole 10 of the inner washer 6 to the center CP4 of outer washer 8, will take a shape other than a circle. Generally, the shape of the area A will depend on various factors such as the type of shape selected for the holes 10, 14 of the washers 6, 8 and for the inner and outer surfaces 18, 20, 22, 24 of the washers 6, 8; and the amount of offset distance D1, D2 between the centers CP1, CP3 of the holes 10, 14 of the washers 6, 8 and the centers CP2, CP4 of their respective washers 6, 8. For example, as depicted in FIG. 14, the shape of the area A, which represents the potential locations of the center CP1 of the hole 10 of the inner washer 6 relative to the center CP4 of the outer washer 8, could be an annular area that is centered around the center CP4 of outer washer 8. An annular area may occur when the holes 10, 14 and the perimeters of the inner and outer surfaces 18, 20, 22, 24 of the inner and outer washers 6, 8 are generally circular but the offset distances D1, D2 of the centers CP1, CP3 of the holes 10, 14 of the washers 6, 8 from the centers CP2, CP4 of their respective washers 6, 8 are not approximately the same. For example, in one of the illustrative examples above wherein the offset distance D1 from the center CP1 of the hole 10 of the inner washer 6 to the center CP2 of the inner washer 6 was approximately one-tenth of an inch (0.100″) and the offset distance D2 from the center CP3 of hole 14 to the center CP4 of outer washer 8 was approximately two-tenths of an inch (0.200″ inches), an annular area centered on the center CP4 of the outer washer 8 will occur. This annular area, which is centered on the center CP4 of the outer washer 8, will have an inner radius of approximately one-tenth of an inch (0.100″ inches) and an outer radius of approximately three-tenths of an inch (0.300″ inches).

As generally shown in FIGS. 1 and 3, in one embodiment, the inner washer's 6 outer surface 20 and the outer washer's 8 outer surface 24 are each conically shaped. In other words, the perimeters of the outer surfaces 20, 24 of the washers 6, 8 are generally circular along the depth of the washers 6, 8 with the perimeter dimensions decreasing substantially linearly along the depth of the washers 6, 8 with the maximum perimeter dimensions occurring proximate the rims portions 11, 16 of the washers 6, 8 and the minimum perimeter dimensions occurring proximate the sides of the washers 6, 8, opposite the rim portion 11, 16 sides. Similarly, where the fastener's 4 head 13 and the inner washer's 6 outer surface 20 are conically shaped, both the inner washer's 6 inner surface 18 and the outer washer's 8 inner surface 22 will also generally be conically shaped. However, in some embodiments, where the fastener head 13 is not conically shaped but the inner washer's 6 outer surface 18 is conically shaped, generally only the outer washer's 8 inner surface 22 will be conically shaped. In some embodiments, the conical shapes of the outer washer's 8 outer surface 20 allow the outer washer 8 to be counter-sunk within a hole of a piece of equipment that is receiving the first washer assembly 2. Thus, in some embodiments, the first washer assembly 2 mounts in the equipment such that its exposed surface is substantially flush with the adjacent surface of the equipment.

In some embodiments, where the inner washer's 6 inner surface 18 is not conical or otherwise adapted to completely receive the fastener's 4 head 13, the fastener's 4 head 13 will not be entirely counter-sunk or recessed within the inner washer 6. In such embodiments, the fastener's 4 head 13 may be a hex-head type bolt head.

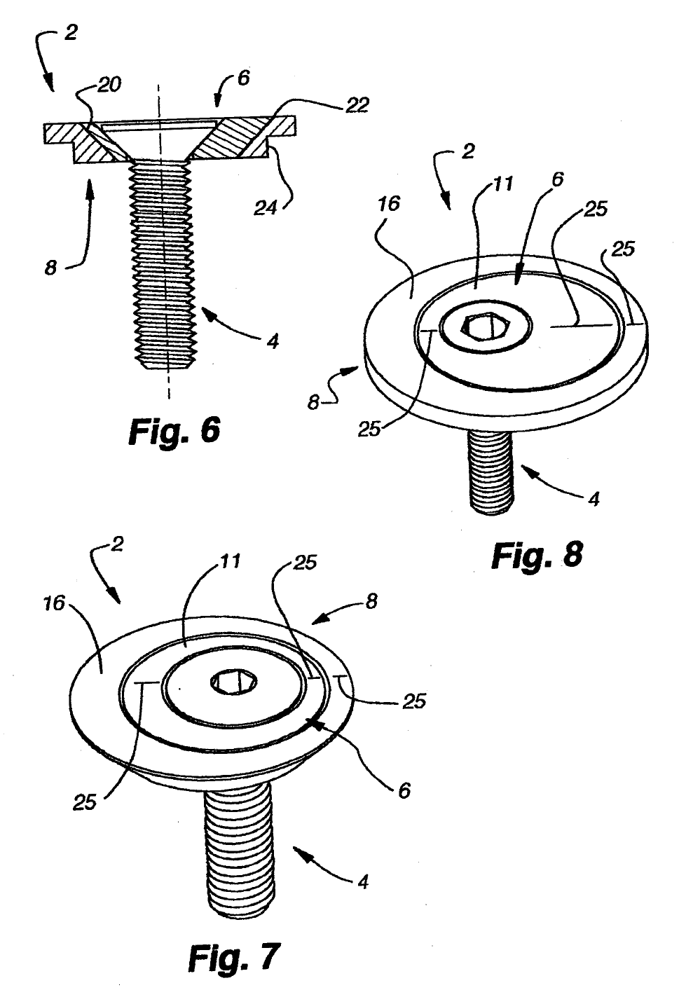

As indicated in FIG. 6, which is a section of one embodiment of the first washer assembly 2 as if taken along section line A-A in FIG. 2, the inner washer's 6 outer surface 20 is conical and the outer washer's 8 outer surface 24 is stepped. In one embodiment, the outer surfaces 20, 24 are both stepped. In one embodiment, the inner washer's 6 outer surface 20 is stepped and the outer washer's 8 outer surface 24 is conical. In one embodiment, the inner washer's 6 outer surface 20 and the outer washer's 8 outer surface 24 are neither conical nor stepped. Other embodiments of the first washer assembly 2 may have some other combination of stepped, conical, or other shapes. One advantage of a conical or stepped outer surface 20 for the inner washer 6 is when the inner surface 22 of the outer washer 24 is adapted to substantially match the outer surface 20 of the inner washer 26 as shown in FIGS. 3 and 6, the inner surface 22 of the outer washer 8 will provide a substantial bearing surface for supporting the inner washer 6 when the fastener 4 is tightened and for transmitting the clamping force generated by the fastener 4, when it is tightened, from the fastener 4 to the items to be secured via the inner and outer washers 6, 8.

In some embodiments where the configuration of the outer surface 24 of the outer washer 8 substantially matches a hole in the equipment and the inner surface 22 of the outer washer 8 substantially matches the outer surface 20 of inner washer 6, the first washer assembly 2 mounts in the equipment such that its exposed surface is substantially flush with the adjacent surface of the equipment as depicted in FIG. 10. In other embodiments, the one or both of the outer surfaces 20, 24 of the washers 6, 8 are configured relative to their respective equipment hole or the inner surface 22 of the outer washer 8 such that the exposed surface of either the outer washer 8, the inner washer 6, or both extend above the surface of the equipment (i.e., the exposed surface of the outer washer 8, the inner washer 6, or both are not flush with the adjacent surfaces of the equipment).

In one embodiment, as shown in FIGS. 7 and 8, which are isometric views of the first washer assembly 2 assembled, the rim portions 11, 16 are each provided with one or more indicator marks 25. In one embodiment, as indicated in FIG. 7, the marks 25 are positioned to indicate when the washers 6, 8 are oriented, as shown in FIGS. 4 and 5, to achieve maximum offset between the center CP1 of hole 10 and the center CP4 of the outer washer 8. In one embodiment, as shown in FIG. 8, the marks 25 are positioned to indicate when the washers 6, 8 are oriented such to achieve minimum offset, as shown in FIGS. 2 and 3, between the center CP1 of the hole 10 of the inner washer 6 and the center CP4 of the outer washer 8.

In one embodiment, at least one of the washers 6, 8 is magnetic such that the inner washer 6 is retained within the outer washer 8 and is still displaceable within the hole 14 of the outer washer 8. In some embodiments, the outer washer 8 is crimped in on the inner washer 6 in such a manner that the inner washer 6 is retained within the outer washer 8 and still displaceable within the hole 14 of the outer washer 8.

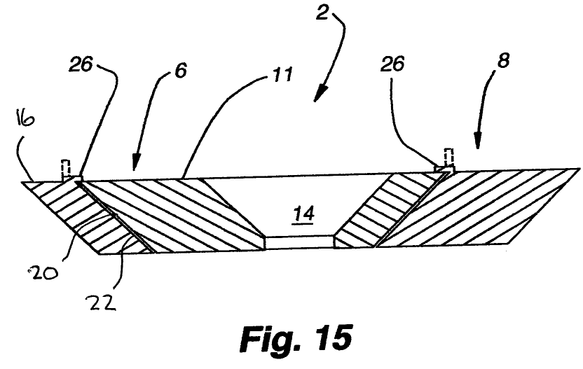

Referring to FIG. 15, one embodiment of crimping the outer washer 8 in on the inner washer 6 is illustrated; methods of crimping the outer washer 8 in on the inner washer 6 other than the method illustrated in FIG. 15 may be utilized. Specifically, a crimp tab 26 extends from rim portion 16 of the outer washer 8 as depicted by the phantom line indicating a general position of the crimp tab 26 prior to being crimped in on the inner washer 6. When inner washer 6 is inserted into the hole 14 of the outer washer 8, the crimp tab 26 is crimped in on the inner washer 6. The crimp tab 26 may be a single continuous member with a length that substantially extends around the perimeter of the hole 14 of the outer washer 8 or a single continuous member with a length that extends around a portion of the perimeter of the hole 14 of the outer washer 8. Alternatively, the crimp tab 26 may be multiple members with discrete lengths that are located at discrete locations around the perimeter of the hole 14 of the outer washer 8.

As discussed above with respect to conical and stepped surfaces, when the outer washer's 8 inner surface 22 substantially matches the inner washer's 6 outer surface 20 (as depicted in FIG. 15) and the inner washer's 6 outer surface 20 is conical (as depicted in FIG. 1), is stepped, or generally has perimeter dimensions that decrease along the depth of the inner washer 6 with the maximum perimeter dimensions occurring proximate the rim portion 11 side and the minimum perimeter dimensions occurring proximate the side of the inner washer 6 opposite the rim portion 11 side, the outer washer's 8 inner surface 22 will support the inner washer 6 on the side of the inner washer 6 opposite the rim portion 11 of the inner washer 6. Thus, crimp tabs are not required on the side of the outer washer 8 opposite the rim portion 16 side. However, a crimp tab, similar to the crimp tab described above, can be provided on the side of the outer washer 8 opposite the rim portion 16 side. Further, it may be desirable to provide to a crimp tab when the outer surface 20 of the inner washer 6 and the inner surface 22 of the outer washer 8 are not configured such that the inner surface 22 of the outer washer 8 supports the inner washer 6.

While in some embodiments, as explained in the preceding discussion, the holes 10, 14 in the washers 6, 8 are offset from the respective washer centers CP2, CP4, it is contemplated that, in some embodiments, the hole 14 in the outer washer 8 may be centered as opposed to offset while the hole 10 in the inner washer 6 remains offset. Similarly, in some embodiments, it is contemplated that the hole 10 in the inner washer 6 may be centered as opposed to offset while the hole 14 in the outer washer 8 remains offset.

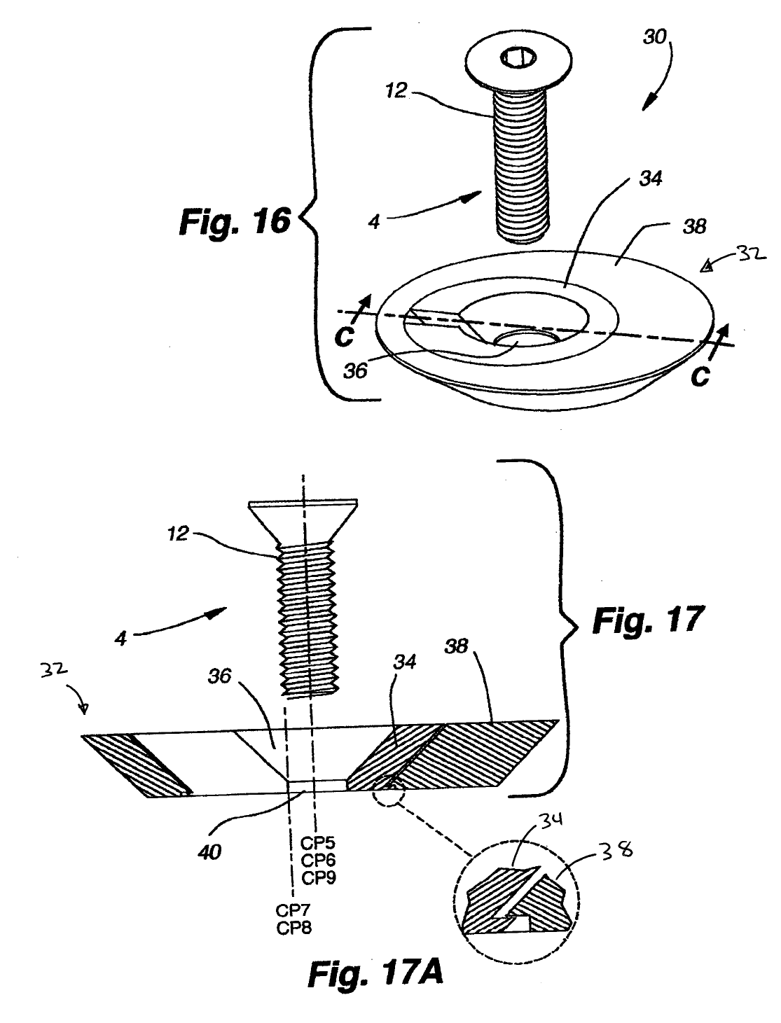

FIGS. 16 and 17 are views of another embodiment of the subject invention. As shown in FIG. 16, a second washer assembly 30 includes the fastener 4 and a washer 32. The washer 32 has an inner portion 34 including a first hole 36 therein adapted for receiving the shaft 12 of the fastener 4 and an outer portion 38 including a second hole 40 therein with a perimeter encompassing the first hole 36. As shown in FIG. 17, the center CP6 of the first hole 36 is offset from the center CP7 of the inner portion 34, and the center CP8 of the second hole 40 is offset from the center CP9 of the outer portion 38.

The inner portion 34 is adapted to be moveable, such as by rotation, translation, etc., relative to the outer portion 38. As shown in FIG. 17A, the inner portion 34 may be associated with the outer portion 38 by inserting a clasp member extending from the inner portion 34 into a slot in the outer portion 38 adapted to receive the clasp member. As shown in FIG. 16, the inner portion 34 has a slit within its body, thereby permitting the inner portion 34 to be forced inwards towards the center CP6 of the first hole 36 when associating the clasp member with the slot. When the clasp member is properly aligned with the slot, the force on the inner portion 34 may be released, thereby allowing the inner portion 34 to expand away from the center CP6 of the first hole 36 and the clasp member to engage the slot. Other means of associating the inner portion 34 with the outer portion 38 while permitting the inner portion 34 to be movable relative to the outer portion 38 may be utilized.

Turning back to FIG. 17, the outer portion 38 is adapted to be moveable relative to one of the two or more items to be joined. Thus, by moving the inner portion 34 relative to the outer portion 38 and moving the outer portion 38 relative to an item to be joined, the position of the longitudinal axis CP5 (i.e., center line) of the fastener 4 may be adjusted relative to the center CP9 of the outer portion 38. In other words, because the inner and outer portions 34, 38 both are moveable and both have holes 36, 40 therein whose centers CP6, CP8 do not coincide with their respective centers CP7, CP9, the position of the fastener's 4 centerline CP5 relative to the center CP9 of the outer portion 38 may be varied along both the X and Y axes. Thus, the washer assembly 30 is advantageous because it makes it possible to position the fastener 4 through holes in items to be joined by tightening (or otherwise fastening) the fastener 4 when the holes in the items are not perfectly aligned. In one embodiment, once the fastener 4 is properly aligned and passing through the holes of the two or more items to be joined, the fastener 4 may be tightened to prevent further displacement of the inner and outer portions 34, 38. Other attributes of washer assembly 30 (e.g., minimum and maximum offsets, conically or stepped surfaces, indicator marks, etc.) are similar to those of the first washer assembly 2 as described above.

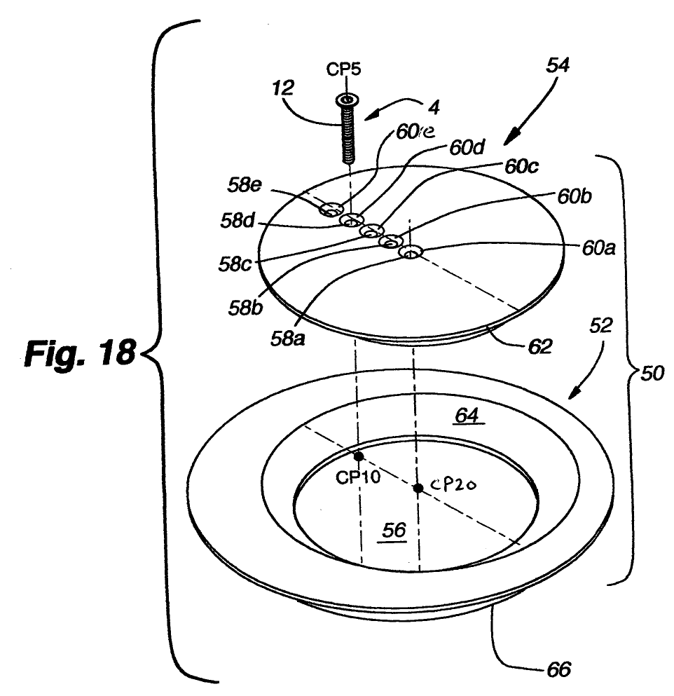

FIG. 18 is an isometric view of another embodiment of the subject invention. As shown in FIG. 18, a third washer assembly 50 includes the fastener 4, an outer washer 52, and an inner washer 54. The outer washer 52 includes a hole 56 therein adapted to receive the inner washer 54 The center CP20 of the hole 56 of the outer washer 52 is offset from the center CP10 of the outer washer 52 in a manner similar to the one offset depicted in FIG. 1B for outer washer 52. In some embodiments, however, the center of the hole 56 of the outer washer 52 substantially coincides with the center of the outer washer 52; in other words, the offset distance between the center of hole 56 and the center of the outer washer 52 is substantially zero. The inner washer 54 includes two or more holes 58a-e, each hole 58a-e adapted to receive the shaft 12 of the fastener 4. By moving the inner washer 54 relative to the outer washer 52 and changing which hole 58a-e wherein the fastener 4 is inserted, the position of the longitudinal axis CP5 (i.e., center line) of the fastener 4 may be adjusted relative to the center CP10 of the outer washer 52.

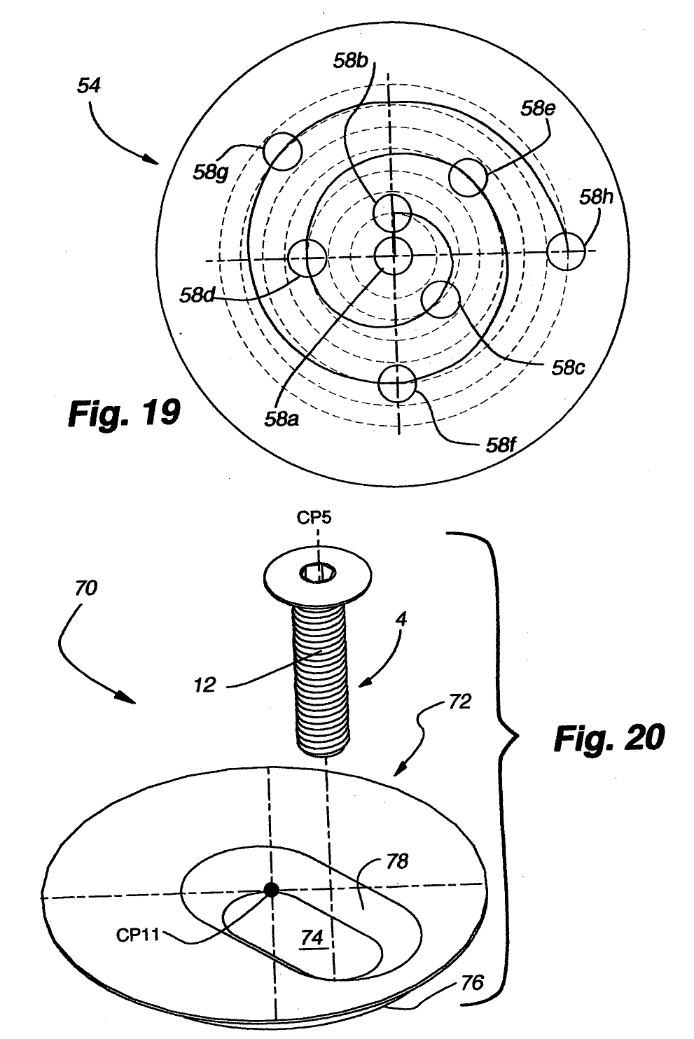

As shown in FIG. 18, the holes 58a-e, in some embodiments, may be aligned along a generally straight line. In other embodiments, however, the holes 58a-h may be aligned along a generally spiral path as shown in FIG. 19 or the holes may be randomly located throughout the inner washer 54. The selected locations of the holes may be governed by considerations such the size of the shaft 12 of the fastener 4, the minimum spacing between holes to maintain a minimum strength of the inner washer 54 material between the holes, the desired coverage area for aligning the shaft 12 of the fastener 4 with holes of items to be joined, etc.

As shown in FIG. 18, the holes 56, 58a-e and inner and outer surfaces 60a-e, 62, 64, 66 of the inner and outer washers 54, 52 have generally circular perimeters along the depths of the washers 54, 52. As discussed in more detail above, however, other geometric perimeters that allow the inner washer 54 to be movable relative to outer washer 52, and the outer washer 52 to be movable relative to one or more items to be joined, may be utilized. Additionally, as discussed in more detail above, the inner and outer surfaces 60a-e, 62, 64, 66 of washers 54, 52 may be conically shaped or may be stepped. In some embodiments, as discussed in more detail above in connection with the first washer assembly 2, the outer washer 52 is crimped in on the inner washer 54. Specifically, a method similar to the crimping method illustrated in FIG. 15 for the first washer assembly 2 could be utilized to crimping outer washer 52 in on inner washer 54. Similarly as with the first washer assembly 2, other methods of crimping outer washer 52 in on inner washer 54 could be utilized. In some embodiments, as discussed in more detail above, at least one of the washers 52, 54 is magnetic.

With reference to 18, by selecting the hole 58a-e that receives the fastener 4, moving the inner washer 54 relative to the outer washer 52, and moving the outer washer 52 relative to an item to be joined, the position of the longitudinal axis CP5 (i.e., centerline) of the fastener 4 may be adjusted relative to the center point CP10 of the outer washer 52. In other words, because the shaft 12 of the fastener 4 can be inserted at multiple locations within the inner washer 54, the inner washer 54 is movable relative to the outer washer 52, and the outer washer 52 is movable relative to an item to be joined, the position of the fastener's 4 centerline CP5 relative to the center CP10 of the washer 52 may be varied along both the X and Y axes. Thus, the third washer assembly 50 is advantageous because it makes it possible to position the fastener 4 through holes in items to be joined by tightening (or otherwise fastening) the fastener 4 when the holes in the items are not perfectly aligned. In one embodiment, once the fastener 4 is properly aligned and passing through the holes of the two or more items to be joined, the fastener 4 may be tightened to prevent further displacement of the washers 52, 54.

FIG. 20 is an isometric view of another embodiment of the subject invention. As shown in FIG. 20, a fourth washer assembly 70 includes the fastener 4 and a washer 72. The washer 72 includes a slotted hole 74 therein adapted for receiving the shaft 12 of the fastener 4. The shaft 12 of the fastener 4 may be located at multiple locations within a portion of the length of the slotted hole, and the washer 72 may be moved relative to one of the two or more items to be joined. In some embodiments, a second washer adapted to be received within the slotted hole 74 and including a hole adapted to receive the fastener 4 and offset from center of the second washer could be utilized in conjunction with the washer 72. This second washer could be utilized in a manner similar to the inner washer 6 described for the first washer assembly 2.

By changing the location of the shaft 12 of the fastener 4 within the slotted hole 74 and moving the washer 72 relative to the item to be joined, the position of the longitudinal axis CP5 (i.e., center line) of the fastener 4 may be adjusted relative to the center CP11 of the washer 72. In other words, because the shaft 12 of the fastener 4 can be located at multiple locations within a portion of the length of the slotted hole 74 and the washer 72 is movable relative to the items to be joined, the position of the fastener's 4 centerline CP5 relative to the center of the washer CP11 may be varied along both the X and Y axes. Thus, the third washer assembly 70 is advantageous because it makes it possible to position the fastener 4 through holes in items to be joined by tightening (or otherwise fastening) the fastener 4 wherein the holes in the items are not perfectly aligned. In one embodiment, once the fastener 4 is properly aligned and passing through the holes of the two or more items to be joined, the fastener 4 may be tightened to prevent further displacement of the washer 72 or the fastener 4.

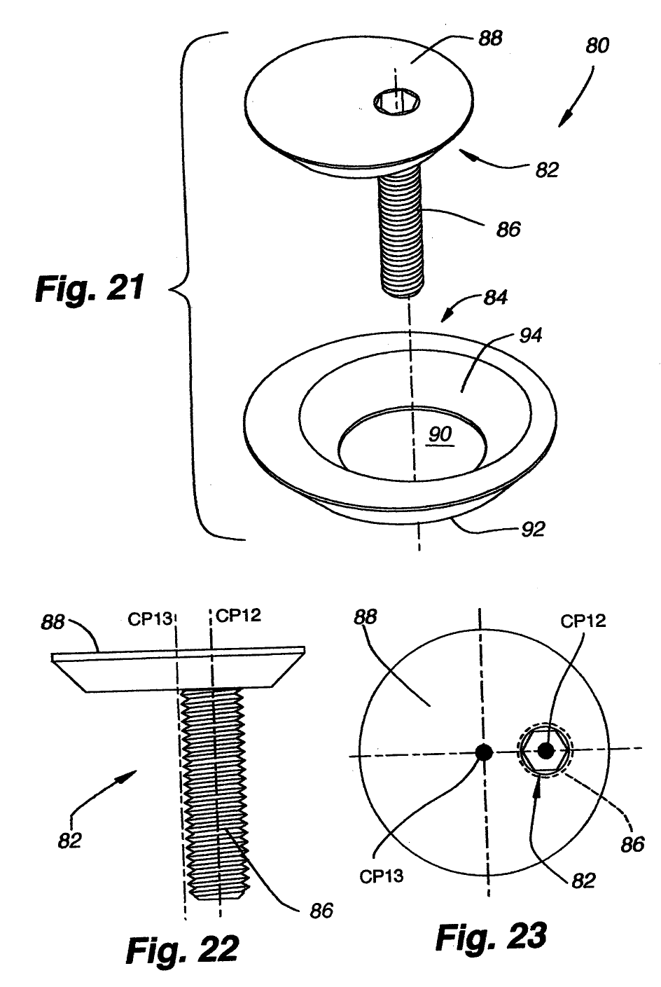

FIGS. 21-23 are views of another embodiment of the subject invention. As shown in FIG. 21, a fifth washer assembly 80 includes an offset fastener 82 and a washer 84. The offset fastener 82 includes a shaft 86 and a head 88. As shown in FIGS. 22 and 23, the longitudinal axis CP12 of the offset fastener 82 is offset from the center CP13 of the head 88. Referring back to FIG. 21, the washer 84 includes a hole 90 adapted for receiving the shaft 86 of the offset fastener 4. Further, in some embodiment as depicted in FIG. 21, the hole 90 is adapted for receiving the head 88 of the offset fastener 82. The center of the hole 90 is offset from the center of the washer 84. In some embodiments, however, the center of the hole 90 substantially coincides with the center of the washer 84. The head 88 of the offset fastener 4 is movable relative to the washer 84, and the washer 84 is movable relative to one or more items to be joined.

By moving the head 88 of the offset fastener 82 relative to the washer 84 and moving the washer 84 relative to the item to be joined, the position of the longitudinal axis CP12 (i.e., center line) of the offset fastener 82 may be adjusted relative to the center of the washer 84. In other words, because the head 88 and the washer 82 both are movable, the longitudinal axis CP12 of the offset fastener 82 is offset from the center CP13 of the head 88, and the center of hole 90 does not coincide with the center of the washer 84, the position of the offset fastener's 82 centerline CP12 relative to the center of the washer 84 may be varied along both the X and Y axes. Thus, the washer assembly 80 is advantageous the first washer assembly 2 is advantageous because it makes it possible to position the offset fastener 82 through holes in items to be joined by tightening (or otherwise fastening) the offset fastener 82 wherein the holes in the items are not perfectly aligned. In one embodiment, once the offset fastener 82 is properly aligned and passing through the holes of the two or more items to be joined, the offset fastener 82 may be tightened to prevent further displacement of the head 88 and the washer 84. Other attributes of washer assembly x (e.g., minimum and maximum offsets, conically or stepped surfaces, etc.) are similar to those of washer assemblies described above.

In some embodiments of washer assembly 80, it may be desirable to permit the shaft 86 to rotate relative to the head 88 in a plane substantially perpendicular to the longitudinal axis CP12 of the offset fastener 82. Such an embodiment may be advantageous when it is not possible to thread a nut or other such item onto the shaft 86 or when it is desired to thread the shaft into an item. A method similar to the method of associating the inner portion 34 of washer 32 with the outer portion 38 of washer 32 as shown in FIGS. 16 and 17 could be utilized of associate the shaft 86 of the offset fastener 82 with the head 88 of the offset fastener 82 while permitting the shaft 86 of the offset fastener 82 to rotate relative to the head 88. In other embodiments of washer assembly 80, the head could be replaced with a washer such as the inner washer 6 of the first washer assembly 2 and the shaft 86 (e.g., a threaded stud) could be connected to the washer by welding the shaft 86 to the washer, by threading the shaft 86 into the washer, by snapping the shaft 86 into the washer, or by using other known connection means.

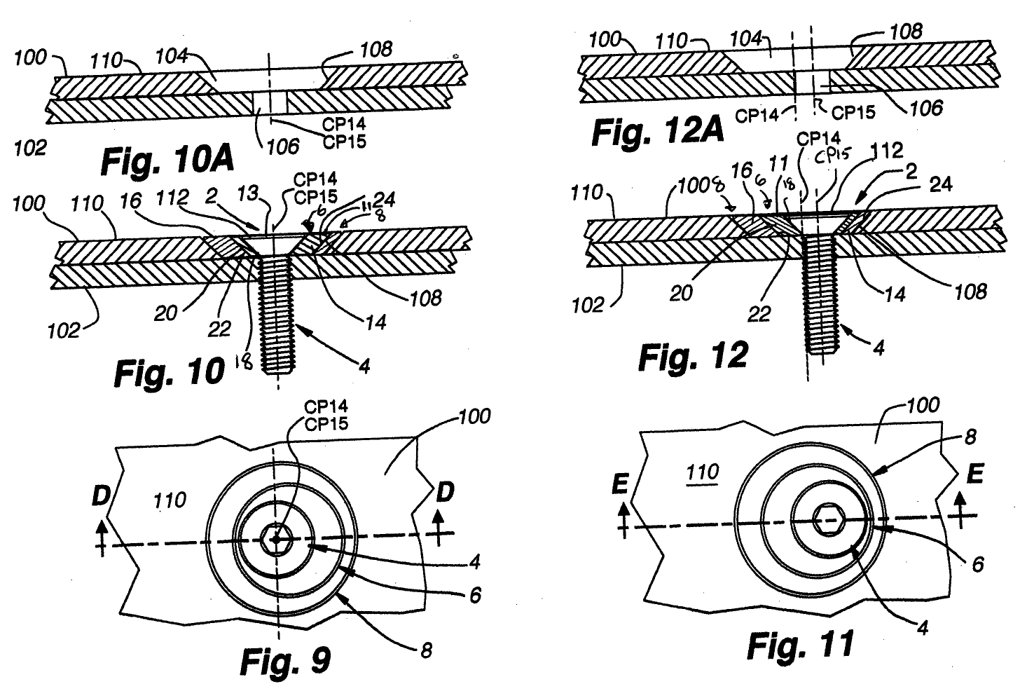

Methods of utilizing the first and second washer assemblies 2, 30 will now be discussed. Referring to FIGS. 9-12, one method will be described with reference to the first washer assembly 2. FIG. 9 is a plan view of a first item 100 to be secured to a second item 102 (shown in FIG. 10) via a first hole 104 in the first item 100 and a second hole 106 in the second item 102 (holes 104, 106 shown in FIG. 10A) wherein the center CP14 of the first hole 104 coincides with the center CP15 of the second hole 106. FIG. 10 is a section taken along section line D-D in FIG. 9 and illustrating the first washer assembly 2 being employed to secure together the items 100, 102. FIG. 10A is similar to FIG. 10 except the first washer assembly 2 is not illustrated. FIG. 11 is a plan view of the first item 100 to be secured to a second item 102 (shown in FIG. 12) via the first hole 104 in the first item 100 and the second hole 106 in the second item 102 (holes 104, 106 shown in FIG. 12A) wherein the center CP14 of the first hole 104 is offset from the center CP 15 of the second hole. FIG. 12 is a section taken along section line E-E in FIG. 11 and illustrating the first washer assembly 2 being employed to secure together the items 100, 102. FIG. 12A is similar to FIG. 12 except the first washer assembly 2 is not illustrated.

A user desires to attach the first item 100 to the second item 102 via one or more fasteners or similar attachment devices. For example, the item 100 may be a sub-frame of a vehicle and the second item 102 may be an after-market skid plate: In another example, the first item 100 may be a rooftop air handler unit and the second item 102 may be a roof curb. These are just two examples of the many types of items that may be connected via fasteners. Regardless of the type of items being connected, the first and second items 100, 102 each have holes 104, 106 that must be aligned in order for the fasteners to pass through the holes and secure the items together.

Because of the variations in manufacturing tolerances and the equipment incompatibilities that result from overhauls, modifications, retrofits, after-market add-ons, bent or deformed equipment (e.g., a bent skid plate), etc., the situation often arises where the holes 104, 106 in the items 100, 102 will not align sufficiently to allow a fastener 4 to pass through the holes 104, 106. To overcome this situation, as indicated in FIGS. 10A and 12A, the first hole 104 in the first item 100 may be sized such that the perimeter of the first hole 104 encompasses the perimeter of the second hole 106 in the second item 102.

As shown in FIGS. 10 and 12, a first washer assembly 2 may be selected that has an outer washer 8 with an outer surface 24 that approximately matches the surface 108 of the first hole 104. In some applications, however, the outer washer's 8 outer surface 24 may not approximately match the surface 108 of the first hole 104. For example, the perimeter of the outer washer's 8 outer surface 24 may be greater than or less than the perimeter of the surface 108 of the first hole 104. An advantage, however, of approximately matching the outer surface 24 of the outer washer 8 with the surface 108 of the first hole 104 is that movement of the outer washer 8 relative to the first hole 104 will be reduced when the fastener 4 is tightened. Another advantage of approximately matching the outer surface 24 of the outer washer 8 with the surface 108 of the first hole 104 is that when the surface 108 of the first hole 104 is conical, as generally depicted in FIGS. 10 and 12, stepped, or otherwise has a perimeter that generally increases when moving along the depth of the first hole 104 from the side adjacent the second item 102, the outer surface 24 of the outer washer 8 will bear on the surface 108 of the first hole 104, thereby potentially enhancing the effectiveness of securing the items 100, 102 together via the clamping force generated when the fastener 4 is tightened or otherwise fastened.

Turning back to FIGS. 10 and 12, an inner washer 6 may be selected that has an outer surface 20 that approximately matches an inner surface 22 of the outer washer 8. In some applications, however, the inner washer's 6 outer surface 20 may not approximately match the inner surface 22 of the outer washer 8. For example, the perimeter of the inner washer's 6 outer surface 20 may be greater than or less than perimeter of the inner surface 22 of the outer washer 8. An advantage, however, of approximately matching the outer surface 20 of the inner washer 6 with the inner surface 22 of the outer washer 8 is that movement of the inner washer 6 relative to outer washer 8 will be reduced when the fastener 4 is tightened or otherwise fastened. Another advantage of approximately matching the outer surface 20 of the inner washer 6 with the inner surface 22 of the outer washer 8 is that when the inner surface 22 of the outer washer is conical, as generally depicted in FIGS. 10 and 12, stepped, or otherwise has a perimeter that generally decreases when moving along the depth of the outer washer 8 from the rim portion 16 side, the outer surface 20 of the inner washer 6 will bear on the inner surface 22 of the outer washer 8, thereby potentially enhancing the effectiveness of securing the items 100, 102 together via the clamping force generated when the fastener 4 is tightened or otherwise fastened.

Turning back to FIGS. 10 and 12, a fastener 4 may be selected that has a head 13 that approximately matches an inner surface 18 of the inner washer 6. In some applications, however, the head 13 of the fastener 4 may not approximately match the inner surface 18 of the inner washer 6. For example, the perimeter of the head 13 may be greater than or less than the perimeter of the inner surface 18 of the inner washer 6. An advantage, however, of approximately matching the head 13 of the fastener 4 with the inner surface 18 of the inner washer 6 is that when the inner surface 18 of the inner washer 6 is conical, as generally depicted in FIGS. 10 and 12, stepped, or otherwise has a perimeter that generally decreases when moving along the depth of the outer washer 6 from the rim portion 11 side, the head of fastener 4 will bear on the inner surface 22 of the inner washer 6, thereby potentially enhancing the effectiveness of securing the items 100, 102 together via the clamping force generated when the fastener 4 is tightened or otherwise fastened.

Turning back to FIGS. 10 and 12, the first washer assembly 2 may be installed, as shown in these figures, such that the outer washer 8 resides in the first hole 104, the inner washer 6 resides in the hole 14 of the outer washer 8, and the fastener's 4 head 13 resides in the hole 10 of the inner washer 6. In some applications, however, when the first washer assembly 2 is installed, the outer washer 8 may or may not reside in the first hole 104, the inner washer 6 may or may not reside in the hole 14 of the outer washer 8, and the fastener's 4 head 13 may or may not reside in the hole 10 of the inner washer 6. For example, if the perimeter of the outer surface 24 of the outer washer 8 is greater than the perimeter of the first hole 104, then a portion of the side of the outer washer 8 opposite the rim portion 16 side may bear on an exposed surface 110 of the first item 100 rather than the outer washer 8 residing in the first hole 104. Similarly, a portion of the side of the inner washer 6 opposite the rim portion 11 side of the inner washer 6 may bear on the rim portion 16 side of the outer washer 8 rather than reside in hole 14 of the outer washer 8, and the head 13 of the fastener may bear on the rim portions 11, 16 of the washers 6, 8 rather than reside in hole 10 of the inner washer 6. Further, a portion of the outer washer 8 may reside in the first hole 104 while another portion of the outer washer 8 bears on the exposed surface 110 of the first item 100. Similarly, a portion of the inner washer 6 may reside in the outer washer's 8 hole 14 while another portion of the inner washer 6 bears on the rim portion 16 side of the outer washer 8. Other combinations of the outer washer 8, the inner washer 6, and the head 13 residing, partially residing, or not residing within holes 104, 14, and 10 respectively and of bearing on various surfaces such as the exposed surface 110 of the first item 100, the rim portion 16 side of the outer washer 8, and the rim portion 11 side of the inner washer 6 are possible.

Turning back to FIGS. 10 and 12, the rim portion 11, 16 sides of the washers 6, 8 are shown as being substantially flush with the exposed surface 110 of the first item 100 and the exposed surface 112 of the head 13 as being substantially flush with the exposed surface 110 of the first item 100. In other applications, however, the rim portion 11, 16 sides of one or both of the washers 6, 8 may extend above the exposed surface 110 of the first item 100 or may be below the exposed surface 110 of the first item 100. Similarly, in other applications, the exposed surface 112 of the head 13 may extend above the exposed surface 110 of the first item 100 or may be below the exposed surface 110 of the first item 100.

To sufficiently align the fastener 4 with the first hole 104 in the first item 100 and the second hole 106 in the second item 102, the outer washer 8 may be moved relative to the first item 100 and the inner washer 6 moved relative to the outer washer 8. For example, with reference to FIGS. 10 and 12, the outer washer 8 may be rotated within the first hole 104 in the first item 100 and the inner washer 6 may be rotated within the hole 14 of the outer washer 8 so that the shaft 12 of the fastener 4 may pass through the hole 10 of the inner washer 6, the hole 14 of the outer washer 8; the first hole 104 of the first item 100, and the second hole 106 of the second item 102 as depicted in FIGS. 10 and 12. The previous example is merely illustrative and other methods of moving the outer washer 8 relative to the first item 100 and the inner washer 6 relative to the outer washer 8 may be utilized to align the holes 10, 14, 104, 106 in the inner washer 6, the outer washer 8, the first item 100, and the second item 102.

Once the holes 10, 14, 104, 106 in the inner washer 6, the outer washer 8, the first item 100, and the second item 102 are properly aligned, the fastener 4 may be used to secure items 100, 102. The securing force imposed by the fastener 4 on the items 100, 102 could be generated by tightening the fastener 4 against the items 100, 102 using a nut (not shown), could be generated by threading the fastener 4 into one of the items 100, 102, or by could be generated by other known means of using a fastener 4 to secure items together.

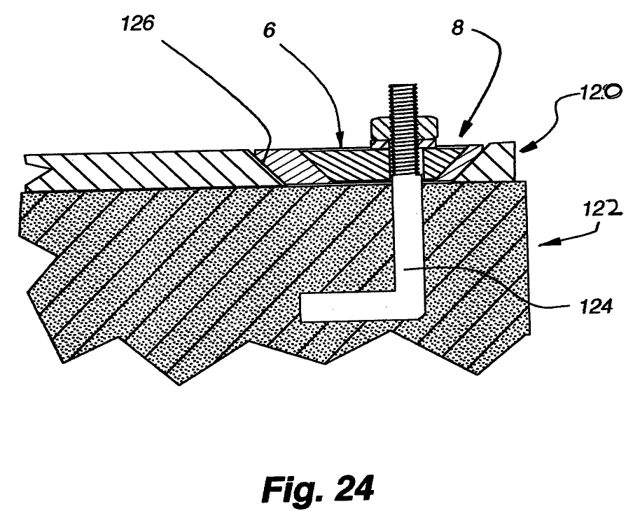

Another method of utilizing the first and second washer assemblies 2, 30 will now be discussed with reference to FIG. 24. As depicted in FIG. 24, a first item 120 is to be secured to a second item 122 using a fastener 124 that is integral with the second item 122. As an example, the first item 122 may be a base plate and the second item may be a foundation with an anchor bolt. As shown in FIG. 24, an inner washer 6 and outer washer 8 may be used in conjunction with a hole 126 in first item 120 to align hole 126 with the fastener 124 and to provide a surface for engaging a securing member such a nut (not shown) that is used in conjunction with the fastener 124 to secure together first item 120 to the second item 122. As described above, the outer washer 8 may be moved relative to the first item 120 and the inner washer 6 may be moved relative to the outer washer 8 in order to align the holes in the washers 6, 8 and the hole 126 in the first item 120 with the fastener 124. In some applications, it may be desirable to make the washers 6, 8 at least partially integral with the first item 120 by welding, gluing, or otherwise bonding the washers to each other and to the first item 120 after aligning the holes in the washers 6, 8 and the hole in the first item 120 with the fastener 124.

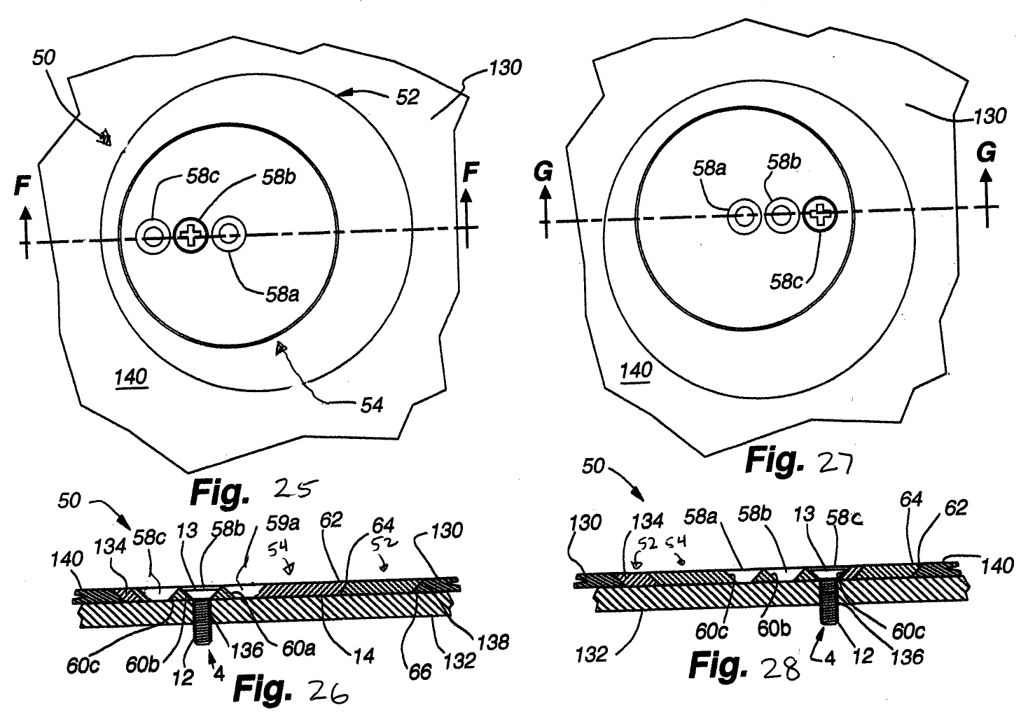

A method of utilizing the third washer assembly 50 will now be discussed with reference to FIGS. 25-28. FIG. 25 is a plan view of a first item 130 to be secured to a second item 132 (shown in FIG. 26). FIG. 26 is a section taken along section line F-F in FIG. 25 and illustrating the washer assembly 50 being employed. FIG. 27 is a plan view similar to FIG. 25 except a second hole 136 in the second item 132 (shown in FIG. 28) has a different location relative to a first hole 134 in the first item 130. FIG. 28 is a section taken along section line G-G in FIG. 27 and illustrating the washer assembly 50 being employed.

As described in more detail above with respect to the first washer assembly 2, the situation often arises where a first hole 134 in the first item 130 will not align sufficiently with a second hole 136 in the second item 134 to allow a fastener 4 to pass through the holes 134, 136. To overcome this situation, the first hole 134 in the first item 130 may be sized such that the perimeter of the first hole 134 encompasses the perimeter of the second hole 136 in the second item 132. In a manner similar to that discussed above with reference to the first washer assembly 2, an outer washer 52 may be selected that has an outer surface 66 that approximately matches the perimeter of a surface 138 of the first hole 134. In some applications, however, the outer washer's 52 outer surface 66 may not approximately match the surface 138 of the first hole 134. For example, the perimeter of the outer washer's 52 outer surface 66 may be greater than or less than the perimeter of the surface 138 of the first hole 134. The advantages of having the surfaces 66, 138 approximately match, however, are similar to the advantages described above for similar elements in the first washer assembly 2.

Turning back to FIGS. 26 and 28, an inner washer 54 may be selected that has an outer surface 62 that approximately matches an inner surface 64 of the outer washer 52. In some applications, however, the inner washer's 54 outer surface 62 may not approximately match the inner surface 64 of the outer washer 52. For example, the perimeter of the inner washer's 54 outer surface 62 may be greater than or less than the perimeter of the inner surface 64 of the outer washer 52. The advantages of having the surfaces 62, 64 approximately match, however, are similar to the advantages described above for similar elements in the first washer assembly 2.

Turning back to FIGS. 26 and 28, a fastener 4 may be selected that has a head 13 that approximately matches at least one of the inner surfaces 60a-c of the inner washer 54. In some applications, however, the head 13 of the fastener 4 may not approximately match any of the inner surfaces 60a-c of the inner washer 54. For example, the perimeter of the head 13 may be greater than or less than the perimeters of the inner surfaces 60a-c of the inner washer 54. The advantage of having the head 13 approximately match the surfaces 60a-c, however, are similar to the advantage described above for similar elements in the first washer assembly 2.

The washer assembly 50 may be installed as shown in these FIGS. 26 and 28 such that the outer washer 52 resides in the first hole 134, the inner washer 54 resides in the hole 56 of the outer washer 52, and the fastener's 4 head 13 resides in one of the holes 58a-c of the inner washer 6. As described in more detail above with respect to the utilization similar components in the first washer assembly 2, in some applications when the washer assembly 50 is installed, the outer washer 52 may or may not reside in the first hole 134, the inner washer 54 may or may not reside in the hole 56 of the outer washer 52, and the fastener's 4 head 13 may or may not reside in one of the holes 58a-c in the inner washer 54.

Exposed surfaces of the washers 52, 54 are shown in FIGS. 26 and 28 as being substantially flush with the exposed surface 140 of the first item 130 and the exposed surface of the head 13 of the fastener 4 is shown as being substantially flush with the exposed surface 140 of the first item 130. In some applications, however, of one or both of the exposed surfaces of the washers 52, 54 may extend above the exposed surface 140 of the first item 130 or may be below the exposed surface 140 of the first item 130. Similarly, in some applications, the exposed surface of the head 13 of the fastener 4 may extend above the exposed surface 140 of the first item 130 or may be below the exposed surface 140 of the first item 130.

To sufficiently align the fastener 4 with the first hole 134 in the first item 130 and the second hole 136 in the second item 132, the outer washer 52 may be moved relative to the first item 130 and the inner washer 54 moved relative to the outer washer 52. For example, with reference to FIGS. 26 and 28, the outer washer 52 may be rotated within the first hole 134 and the inner washer 54 may be rotated within hole 56 of the outer washer 52 so that the shaft 12 of the fastener 4 may pass through one of the holes 60a-c of the inner washer 54, the hole 56 of the outer washer 52, the first hole 134 of the first item 130, and the second hole 136 of the second item 132 as depicted in FIGS. 26 and 28. The previous example is merely illustrative and other methods of moving the outer washer 52 relative to the first item 130 and the inner washer 54 relative to the outer washer 52 may be utilized to align one of the holes 60a-c in the inner washer with the holes 56, 134, 136 in the outer washer 52, the first item 130, and the second item 132.

Once one of the holes 60a-c in the inner washer and the holes 56, 134, 136 in the outer washer 52, the first item 130, and the second item 132 are properly aligned, the fastener 4 may be used to secure items 130, 132. The securing force imposed by the fastener 4 on the items 130, 132 could be generated by tightening the fastener 4 against the items 130, 132 using a nut (not shown), could be generated by threading the fastener 4 into one of the items 130, 132, or by could be generated by other known means of using a fastener 4 to secure items together.

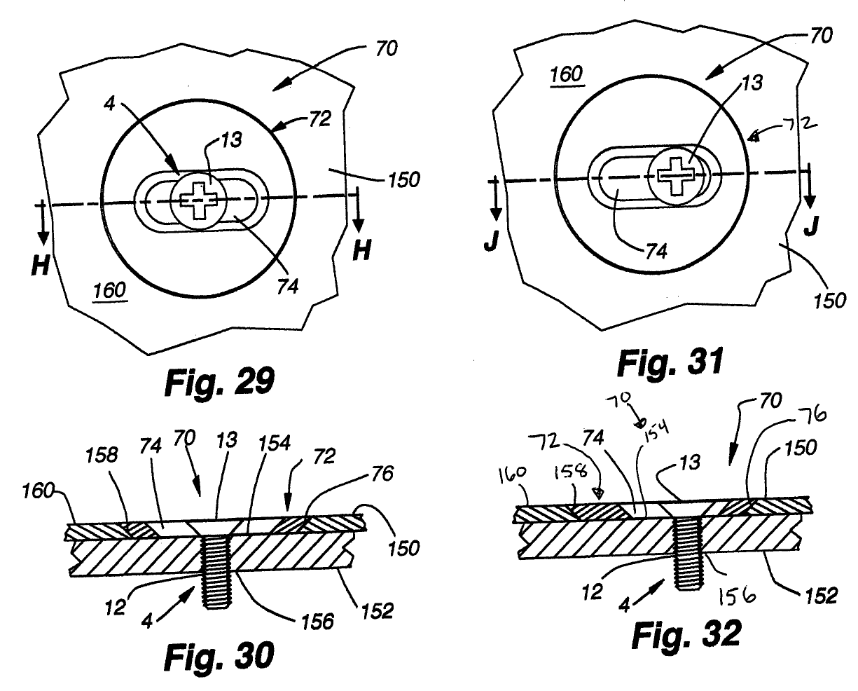

A method of utilizing the fourth washer assembly 70 will now be discussed with reference to FIGS. 29-32. FIG. 29 is a plan view of a first item 150 to be secured to a second item 152 (shown in FIG. 30). FIG. 30 is a section taken along section line H-H in FIG. 29 and illustrating the washer assembly 70 being employed. FIG. 31 is a plan view similar to FIG. 29 except a second hole 156 in the second item 152 (shown in FIG. 32) has a different location relative to a hole in the first item 150. FIG. 32 is a section taken along section line J-J in FIG. 31 and illustrating the washer assembly 70 being employed.

As described in more detail above with respect to the first washer assembly 2, the situation often arises where a first hole 154 in the first item 150 will not align sufficiently with a second hole 156 in the second item 152 to allow a fastener 4 to pass through the holes 154, 156. To overcome this situation, the first hole 154 in the first item 150 may be sized such that the perimeter of the first hole 154 encompasses the perimeter of the second hole 156 in the second item 152. In a manner similar to that discussed above with reference to the first washer assembly 2, a washer 72 may be selected that has an outer surface 76 that approximately matches the perimeter of a surface 158 of the first hole 154. In some applications, however, the washer's 72 outer surface 76 may not approximately match the surface 158 of the first hole 154. For example, the perimeter of the washer's 72 outer surface 76 may be greater than or less than the perimeter of the surface 158 of the first hole 154. The advantages of having the surfaces 76, 158 approximately match, however, are similar to the advantages described above for similar elements in the first washer assembly 2.

The washer assembly 70 may be installed as shown in FIGS. 30 and 32 such that the washer 72 resides in the first hole 154 and the fastener's 4 head 13 resides in the slotted hole 74. As described in more detail above with respect to the utilization similar components in the first washer assembly 2, in some applications, when the washer assembly 70 is installed, the washer 72 may or may not reside in the first hole 154 and the fastener's 4 head 13 may or may not reside in the slotted hole 74 of washer 72.

With reference to FIGS. 30 and 32, an exposed surface of the washer 72 is shown as being substantially flush with the exposed surface 160 of the first item 150 and the exposed surface of the head 13 of the fastener 4 is shown as being substantially flush with the exposed surface 160 of the first item 150. In some applications, however, the exposed surface of the washers 72 may extend above the exposed surface 160 of the first item 150 or may be below the exposed surface 160 of the first item 150. Similarly, in some applications, the exposed surface of the head 13 of the fastener 4 may extend above the exposed surface 160 of the first item 150 or may be below the exposed surface 160 of the first item 150.

To sufficiently align the fastener 4 with the first hole 154 in the first item 150 and the second hole 156 in the second item 152, the washer 72 may be moved relative to the first item 150 and the location of the fastener 4 moved within the slotted hole 74. For example, the washer 72 may be rotated within the first hole 154 and the fastener 4 may be moved within the slotted hole 74 so that the shaft 12 of the fastener 4 may pass through the slotted hole 74 in the washer 72, the first hole 154 of the first item 150, and second hole 156 of the second item 152 as depicted in FIGS. 30 and 32. The previous example is merely illustrative and other methods of moving the washer 72 relative to the first item 150 the fastener 4 may be utilized to align with the holes 74, 154, 156 in the washer 72, the first item 150, and the second item 152.

Once the holes 74, 154, 156 in the washer 72, the first item 150, and the second item 152 are properly aligned, the fastener 4 may be used to secure items 150, 152. The securing force imposed by the fastener 4 on the items 150, 152 could be generated by tightening the fastener 4 against the items 150, 152 using a nut (not shown), could be generated by threading the fastener 4 into one of the items 150, 152, or by could be generated by other known means of using a fastener 4 to secure items together.

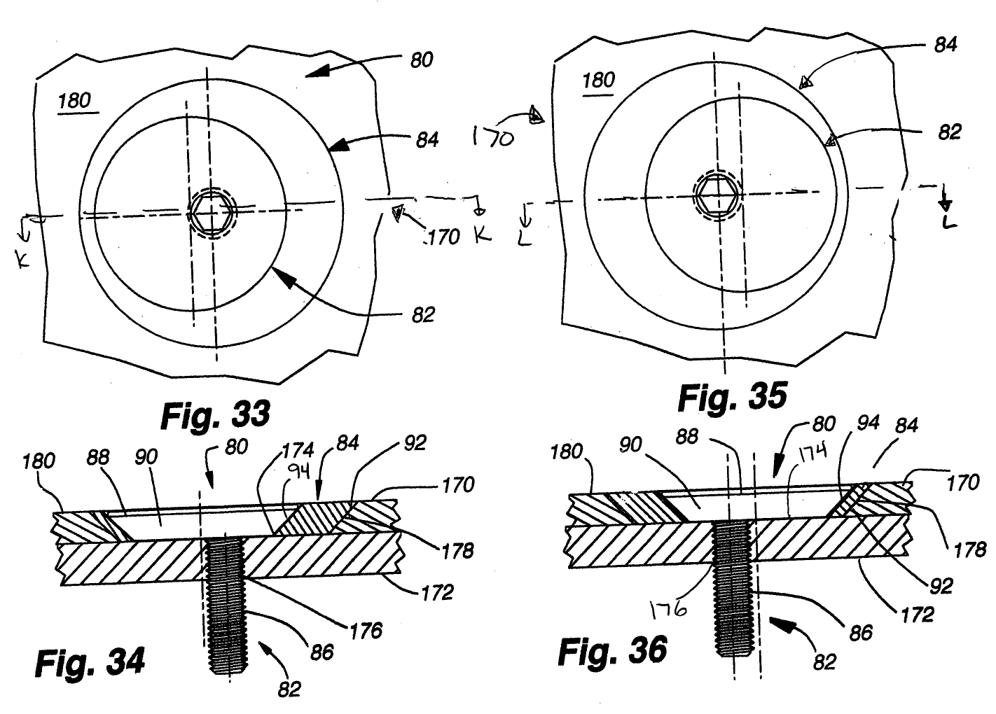

A method of utilizing the fifth washer assembly 80 will now be discussed with reference to FIGS. 33-36. FIG. 33 is a plan view of a first item 170 to be secured to a second item 172 (shown in FIG. 34). FIG. 34 is a section taken along section line K-K in FIG. 33 and illustrating the fifth washer assembly 80 being employed. FIG. 35 is a plan view similar to FIG. 33 except a second hole 176 in the second item 172 (shown in FIG. 36) has a different location relative to a first hole 174 in the first item 130. FIG. 36 is a section taken along section line L-L in FIG. 35 and illustrating the fifth washer assembly 80 being employed.

As described in more detail above with respect to the first washer assembly 2, the situation often arises where a first hole 174 in the first item 170 will not align sufficiently with a second hole 176 in the second item 174 to allow an offset fastener 82 to pass through the holes 174, 176. To overcome this situation, the first hole 174 in the first item 170 may be sized such that the perimeter of the first hole 174 encompasses the perimeter of the second hole 176 in the second item 172. A washer 84 may be selected that has an outer surface 92 that approximately matches the perimeter of a surface 178 of the first hole 174. In some applications, however, the washer's 84 outer surface 92 may not approximately match the surface 178 of the first hole 184. For example, the perimeter of the washer's 84 outer surface 92 may be greater than or less than the perimeter of the surface 178 of the first hole 174. The advantages of having the surfaces 92, 178 approximately match, however, are similar to the advantages described above for similar elements in the first washer assembly 2.

An offset fastener 82 may be selected that has a head 88 that approximately matches the inner surface 94 of the washer 84. In some applications, however, the head 88 of the offset fastener 82 may not approximately match the inner surface 94 of the washer 84. For example, the perimeter of the head 88 of the offset fastener 82 may be greater than or less than the inner surface 94 of the washer 84. The advantage of having the head 88 of the offset fastener 82 approximately match the surface inner surface 94, however, are similar to the advantage described above for similar elements in the first washer assembly 2.

The washer assembly 80 may be installed as shown in FIGS. 34 and 36 such that the washer 84 resides in the first hole 174 and the fastener's 82 head 88 resides in the hole 90 of the washer 84. As described in more detail above with respect to the utilization similar components in the first washer assembly 2, in some applications when the washer assembly 80 is installed, the washer 84 may or may not reside in the first hole 174 and the offset fastener's 82 head 88 may or may not reside in the hole 90 of the washer 84.

With reference to FIGS. 34 and 36, an exposed surface of the washer 84, are shown as being substantially flush with the exposed surface 180 of the first item 170 and the exposed surface of the head 88 of the fastener 82 is shown as being substantially flush with the exposed surface 180 of the first item 170. In some applications, however, the exposed surface of the washer 84 may extend above the exposed surface 180 of the first item 170 or may be below the exposed surface 180 of the first item 170. Similarly, in some applications, the exposed surface of the head 88 of the offset fastener 82 may extend above the exposed surface 180 of the first item 170 or may be below the exposed surface 180 of the first item 170.

To sufficiently align the shaft 86 of the fastener 82 with the first hole 174 in the first item 170 and the second hole 176 in the second item 172, the washer 84 may be moved relative to the first item 170 and the head 88 of the offset fastener 82 may be moved relative to the washer 84. For example, the washer 84 may be rotated within the first hole 174 and the head 88 of the offset fastener 82 may be rotated within hole 90 of the washer 84 so that the shaft 86 of the offset fastener 82 may pass through hole 90 of the washer 84, first hole 174 of the first item 170, and second hole 176 of the second item 172 as depicted in FIGS. 34 and 36. The previous example is merely illustrative and other methods of moving the washer 84 relative to the first item 170 and head 88 of offset fastener 82 relative to the washer 84 may be utilized to align the one with holes 90, 174, 176 in the washer 84, the first item 170, and the second item 172.

Once the holes 90, 174, 176 in the washer 84, the first item 170, and the second item 172 are properly aligned, the offset fastener 82 may be used to secure items 170, 172. The securing force imposed by the offset fastener 82 on the items 170, 172 could be generated by tightening the offset fastener 82 against the items 170, 172 using a nut (not shown), could be generated by threading the fastener 82 into one of the items 170, 172, or by could be generated by other known means of using a fastener to secure items together.

Although the present invention has been described with reference to preferred embodiments, persons skilled in the art will recognize that changes may be made in form and detail without departing from the spirit and scope of the invention.

We claim:

1. An offset washer assembly for use with a fastener, the washer comprising:
an inner washer including a first hole therein adapted to receive the fastener, wherein a center of the first hole is offset from a center of the inner washer; and
an outer washer including a second hole therein adapted to receive the inner washer, wherein a center of the second hole is offset from a center of the outer washer and the inner washer is movable relative to the outer washer to adjust an amount of offset between the center of the first hole and the center of the outer washer.

2. The offset washer assembly of claim 1, wherein the inner washer is movable relative to the outer washer by rotation of the inner washer within the second hole.

3. The offset washer assembly of claim 1, wherein the outer washer is crimped in on the inner washer.

4. The offset washer assembly of claim 1, wherein the outer washer and the inner washer have indicator marks.

5. The offset washer assembly of claim 3, wherein the indicator marks indicate the amount of offset between the center of the first hole and the center of the outer washer.

6. The offset washer assembly of claim 1, wherein a minimum offset distance between the center of the first hole and the center of the outer washer is approximately zero.

7. The offset washer assembly of claim 1, wherein an offset distance from the center of the first hole to the center of the inner washer is approximately equal to an offset distance from the center of the second hole to the center of the outer washer.

8. The offset washer assembly of claim 1, wherein at least one of the washers is magnetic.

9. The offset washer assembly of claim 1, wherein a longitudinal axis of the fastener approximately coincides with the center of the first hole when the fastener is inserted through the first hole.

10. A method for adjusting an offset between a longitudinal axis of a fastener and a center of a washer, the method comprising:
inserting an inner washer including a first hole therein adapted to receive a fastener having a longitudinal axis into an outer washer including a second hole therein adapted to receive the inner washer, wherein a center of the first hole is offset from a center of the inner washer and a center of the second hole is offset from a center of the outer washer;
inserting the fastener through the first and second hole; and
moving the inner washer relative to the outer washer to adjust an amount of offset between the longitudinal axis of the fastener and the center of the outer washer.

11. The method of claim 10, further comprising crimping the outer washer in on the inner washer.

12. The method of claim 10, wherein moving the inner washer relative to the outer washer involves rotating the inner washer within the second hole.

13. A system for joining items, the system comprising:
a fastener;
an inner washer including a first hole therein adapted to receive the fastener, wherein a center of the first hole is offset from a center of the inner washer;
an outer washer including a second hole therein adapted to receive the inner washer, wherein a center of the second hole is offset from a center of the outer washer and the inner washer is movable relative to the outer washer to adjust an amount of offset between the center of the first hole and the center of the outer washer,
a first item including a third hole therein adapted to receive the fastener; and
a second item including a fourth hole therein, the fourth hole sized to encompass the third hole and adapted to receive the outer washer, wherein the outer washer is movable relative to the second item to adjust a location of the center of the second hole relative to a center of the fourth hole.

14. The system of claim 13, wherein the inner washer is movable relative to the outer washer by rotation of the inner washer within the second hole.

15. The system of claim 13, wherein the outer washer is movable relative to the second item by rotation of the outer washer within the fourth hole.

16. The system of claim 13, wherein the outer washer is crimped in on the inner washer.

17. The system of claim 13, wherein the outer washer and the inner washer have indicator marks.

18. The system of claim 17, wherein the indicator marks indicate the amount of offset between the center of the first hole and the center of the outer washer.

19. The system of claim 13, wherein a minimum offset distance between the center of the first hole and the center of the outer washer is approximately zero.

20. The system of claim 13, wherein an offset distance from the center of the first hole to the center of the inner washer is approximately equal to an offset distance from the center of the second hole to the center of the outer washer.

21. The system of claim 13, wherein at least one of the washers is magnetic.

22. The system of claim 13, wherein a longitudinal axis of the fastener approximately coincides with the center of the first hole when the fastener is inserted through the first hole.

23. An offset washer for use with a fastener, the washer comprising:
an inner portion including a first hole therein adapted to receive the fastener, wherein a center of the first hole is offset from a center of the inner portion; and
an outer portion including a second hole therein, wherein the second hole encompasses the first hole, a center of the second hole is offset from a center of the outer portion, and the inner portion is movable relative to the outer portion to adjust an amount of offset between the center of the first hole and the center of the outer portion.

24. The offset washer of claim 23, wherein the inner portion is movable relative to the outer washer by rotation of the inner washer within the second hole.

25. The offset washer of claim 23, wherein the outer portion and the inner portion have indicator marks.

26. The offset washer of claim 25, wherein the indicator marks indicate the amount of offset between the center of the first hole and the center of the outer portion.

27. The offset washer of claim 23, wherein a minimum offset distance between the center of the first hole and the center of the outer portion is approximately zero.

28. The offset washer of claim 23, wherein an offset distance from the center of the first hole to the center of the inner portion is approximately equal to an offset distance from the center of the second hole to the center of the outer portion.

29. The offset washer of claim 23, wherein a longitudinal axis of the fastener approximately coincides with the center of the first hole when the fastener is inserted through the first hole.

30. An offset washer assembly for use with a fastener, the washer comprising:
an inner washer including a plurality of holes therein adapted to receive the fastener, wherein at least one of the plurality of holes has a center offset from the center of the inner washer; and
an outer washer including a second hole therein adapted to receive the inner washer, wherein a center of the second hole is offset from a center of the outer washer and the inner washer is movable relative to the outer washer to adjust an amount of offset between at least one of the centers of the plurality of holes and the center of the outer washer.

31. The offset washer assembly of claim 30, wherein the inner washer is movable relative to the outer washer by rotation of the inner washer within the second hole.

32. The offset washer assembly of claim 30, wherein the outer washer is crimped in on the inner washer.

33. The offset washer assembly of claim 30, wherein the outer washer and the inner washer have indicator marks.

34. The offset washer assembly of claim 33, wherein the indicator marks indicate the amount of offset between a center of at least one of the plurality of holes and the center of the outer washer.

35. The offset washer assembly of washer 30, wherein the plurality of holes are aligned in a generally straight line.

36. The offset washer assembly of claim 30, wherein the plurality of holes are arranged in a spiral pattern.

37. The offset washer assembly of claim 30, wherein the plurality of holes randomly.

38. The offset washer assembly of claim 30, wherein at least one of the washers is magnetic.

39. A washer assembly for securing two or more items, the washer assembly comprising:
a fastener including a head having a center and a shaft having a longitudinal axis, wherein the longitudinal axis of the shaft is offset from the center of the head; and
a washer including a hole therein adapted to receive the fastener, wherein a center of the hole is offset from a center of the washer and the head of the fastener is movable relative to the washer to adjust an amount of offset between the longitudinal axis of the shaft and the center of the washer.

40. The washer assembly of claim 39, wherein the head of the fastener is movable relative to the outer washer by rotation of the head within the hole.

41. The washer assembly of claim 39, wherein the head of the fastener and the washer have indicator marks.

42. The washer assembly of claim 41, wherein the indicator marks indicate the amount of offset between the longitudinal axis and the center of the washer.

43. The washer assembly of claim 39, wherein a minimum offset distance between the longitudinal axis and the center of the washer is approximately zero.

44. The washer assembly of claim 39, wherein an offset distance from the longitudinal axis to the center of the head is approximately equal to an offset distance from the center of the hole to the center of the washer.
